(19) United States
(12) Patent Application Publication
(10) Pub. No.: US 2024/0290346 A1
(43) Pub. Date: Aug. 29, 2024

(54) EMOTION ESTIMATION APPARATUS AND EMOTION ESTIMATION METHOD

(71) Applicant: KABUSHIKI KAISHA TOSHIBA, Tokyo (JP)

(72) Inventor: Daichi HAYAKAWA, Inzai Chiba (JP)

(73) Assignee: KABUSHIKI KAISHA TOSHIBA, Tokyo (JP)

(21) Appl. No.: 18/454,828

(22) Filed: Aug. 24, 2023

(30) Foreign Application Priority Data
Feb. 28, 2023 (JP) 2023-029725

(51) Int. Cl. G10L 25/63; G10L 15/02

(52) U.S. Cl. CPC G10L 25/63; G10L 15/02

(57) ABSTRACT

According to one embodiment, an emotion estimation apparatus includes processing circuitry. The processing circuitry is configured to acquire medium data of a target user in which a medium of the target user is recorded, extract medium features from the medium data of the target user, calculate an emotion feature based on the extracted medium features and an emotion feature extraction model denoting a reference for the medium features of the target user, and estimate an emotion of the target user based on the calculated emotion feature.

### CROSS-REFERENCE TO RELATED APPLICATIONS

This application is based upon and claims the benefit of priority from Japanese Patent Application No. 2023-029725, filed Feb. 28, 2023, the entire contents of which are incorporated herein by reference.

### FIELD

Embodiments described herein relate generally to an emotion estimation apparatus and an emotion estimation method.

### BACKGROUND

Emotion estimation is a technique of estimating users' emotions (e.g., happiness, sadness, anger, etc.) from data collected from users, such as speech data in which users' speech is recorded. Emotion estimation is utilized in various applications such as estimation of customer satisfaction at call centers and monitoring of employees' mental health.

In speech-based emotion estimation, a waveform signal itself of a user's speech, or a feature extracted from the waveform signal of the speech for each analytical frame is taken as an input. Recently, to perform emotion estimation with higher precision, attempts have been made to estimate a user's emotion using characteristics of the user's way of speaking, in addition to the above-described waveform signal or feature.

A technique is known in which a user's speech data is input to a speaker recognition neural network (NN) model which has been prepared in advance by being trained with a large amount of universal speech data, and an output from a hidden layer of the speaker recognition NN is extracted as features of the user's way of speaking. In this technique, features of the speech and features of the way of speaking are extracted for every utterance made by the user, and the user's emotions are estimated based on the two types of extracted features.

However, emotion estimation according to such a method excessively depends on the characteristics of the user's way of speaking at normal times, and the fluctuation of the user's emotions might not be properly extracted. For example, if a user always talks in a bright voice, the user's emotion might be estimated to be always “happy”.

### BRIEF DESCRIPTION OF THE DRAWINGS

FIG. 1 is a block diagram showing an emotion estimation apparatus according to an embodiment.

FIG. 2 is a block diagram showing a hardware configuration of the emotion estimation apparatus according to the embodiment.

FIG. 3 is a flowchart showing an operation of an acquisition unit shown in FIG. 1.

FIG. 4 is a flowchart showing an operation of a medium feature extraction unit shown in FIG. 1.

FIG. 5 is a flowchart showing an operation of a model output unit shown in FIG. 1.

FIG. 6 is a flowchart showing an operation of an emotion feature calculation unit shown in FIG. 1.

FIG. 7 is a flowchart showing an emotion estimation process in an offline operation according to the embodiment.

FIG. 8 is a flowchart showing an emotion estimation process in a real-time operation according to the embodiment.

### DETAILED DESCRIPTION

According to one embodiment, an emotion estimation apparatus includes processing circuitry. The processing circuitry is configured to acquire medium data of a target user in which a medium of the target user is recorded, extract medium features from the medium data of the target user, calculate an emotion feature based on the extracted medium features and an emotion feature extraction model denoting a reference for the medium features of the target user, and estimate an emotion of the target user based on the calculated emotion feature.

Hereinafter, an embodiment will be described with reference to the accompanying drawings. The embodiment relates to a technique of estimating a user's emotion from medium data of the user in which the user's medium is recorded. The medium may denote either a speech, a moving image, or text, and the medium data may include at least one of speech data, moving image data, and text data. Hereinafter, a user who is a target for emotion estimation will be referred to as a “target user” or “specific user”.

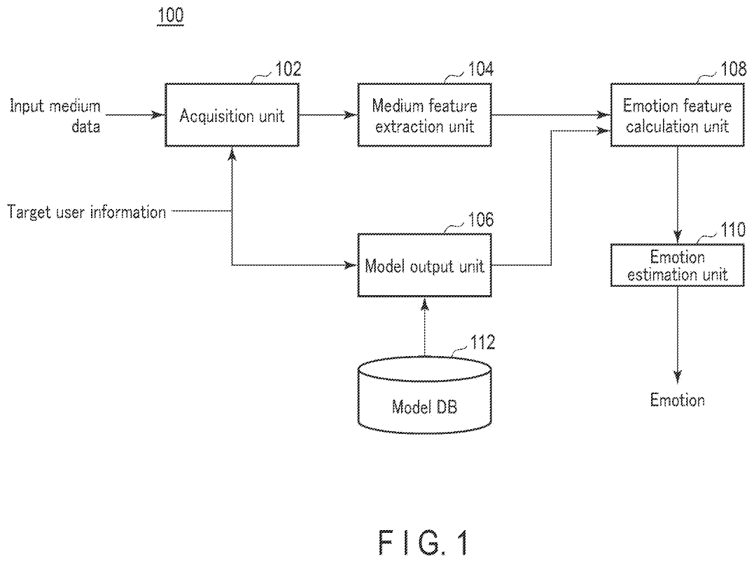

FIG. 1 schematically shows an emotion estimation apparatus 100 according to an embodiment. As shown in FIG. 1, the emotion estimation apparatus 100 includes an acquisition unit 102, a medium feature extraction unit 104, a model output unit 106, an emotion feature calculation unit 108, an emotion estimation unit 110, and a model database (DB) 112. The emotion estimation apparatus 100 may be implemented in a computer such as a server or a personal computer (PC).

The acquisition unit 102 acquires a target user's medium data. For example, the acquisition unit 102 receives medium data acquired by one or more medium data acquisition devices as input medium data, and extracts the target user's medium data from the input medium data based on, for example, target user information for specifying the target user.

The medium feature extraction unit 104 extracts medium features from the target user's medium data acquired by the acquisition unit 102. Specifically, the medium feature extraction unit 104 extracts, for each processing unit in which emotion estimation is to be performed, medium features from the target user's medium data. The medium features of each processing unit are respectively extracted from a plurality of data segments included in medium data corresponding to the processing unit. If the medium is speech, the processing unit may be an utterance, and the data segment may be an analytical frame. If the medium is a moving image, the processing unit may be a predetermined length of time, and the data segment may be a frame image. If the medium is text, the processing unit may be a sentence, and the data segment may be a word.

The model output unit 106 outputs an emotion feature extraction model relating to the target user. The emotion feature extraction model relating to the target user may be generated in advance and stored in the model DB 112. The model DB 112 is configured to store a plurality of emotion feature extraction models respectively relating to a plurality of users. The emotion feature extraction model relating to each user denotes a reference (or a standard) for medium features relating to the user. In other words, the emotion feature extraction model relating to each user denotes medium features corresponding to the user's emotions at normal times. The emotion feature extraction model is generated by calculating a statistic of medium features extracted from the user's medium data over a plurality of processing units.

The model output unit 106 confirms whether or not the emotion feature extraction model relating to the target user exists in the model DB 112. If the emotion feature extraction model relating to the target user exists in the model DB 112, the model output unit 106 retrieves the emotion feature extraction model relating to the target user from the model DB 112, and provides the emotion feature extraction model relating to the target user to the emotion feature calculation unit 108. If the emotion feature extraction model relating to the target user does not exist in the model DB 112, the model output unit 106 generates an emotion feature extraction model relating to the target user based on the medium features extracted by the medium feature extraction unit 104 over a plurality of processing units, and provides the generated emotion feature extraction model relating to the target user to the emotion feature calculation unit 108.

The emotion feature calculation unit 108 calculates emotion features based on the medium features extracted by the medium feature extraction unit 104 and the emotion feature extraction model output from the model output unit 106. Specifically, the emotion feature calculation unit 108 calculates, for each processing unit, a statistic of the medium features in the target user's medium data, and calculates, for each processing unit, an emotion feature representing a difference between the calculated statistic of the medium features and the emotion feature extraction model relating to the target user.

The emotion estimation unit 110 estimates the target user's emotion based on the emotion feature calculated by the emotion feature calculation unit 108. Specifically, the emotion estimation unit 110 estimates, for each processing unit, the target user's emotion from the emotion features of the processing unit.

FIG. 2 schematically shows an example of a hardware configuration of a computer 200 in which the emotion estimation apparatus 100 may be installed. As shown in FIG. 2, the computer 200 includes, as hardware components, a central processing unit (CPU) 202, a random-access memory (RAM) 204, an auxiliary storage device 206, and an input/output interface 208. The CPU 202 is connected to the RAM 204, the auxiliary storage device 206, and the input/output interface 208 to enable communication therebetween.

The CPU 202 is an example of a general-purpose processor capable of executing programs. The RAM 204 includes a volatile memory such as a synchronous dynamic random-access memory (SDRAM), and is used as a working area by the CPU 202. The auxiliary storage device 206 includes a non-volatile memory such as a hard disk drive (HDD) or a solid-state drive (SSD), and stores data and various programs including an emotion estimation program.

The CPU 202 operates in accordance with the programs stored in the auxiliary storage device 206. Being executed by the CPU 202, the emotion estimation program causes the CPU 202 to perform processing relating to the emotion estimation apparatus 100, to be described below. In accordance with the emotion estimation program, the CPU 202 operates as, for example, the acquisition unit 102, the medium feature extraction unit 104, the model output unit 106, the emotion feature calculation unit 108, and the emotion estimation unit 110 included in the emotion estimation apparatus 100. The auxiliary storage device 206 functions as the model DB 112.

The input/output interface 208 includes an interface for connecting an input device and an output device. The input device is a device that allows a system user (a human operator who operates the emotion estimation apparatus 100) to input information, and examples include a keyboard and a mouse. The output device is a device that outputs information to the system user, and examples include a display device and a speaker.

If a client-server model is adopted, the computer 200 may include a communication interface in place of or in addition to the input/output interface 208. The CPU 202 communicates with a client used by the system user via the communication interface. The CPU 202 receives an input by the system user from the client via the communication interface, and transmits, to the client, information to be presented to the system user via the communication interface.

It is to be noted that the computer 200 may include a dedicated processor such as a field-programmable gate array (FPGA) or an application-specific integrated circuit (ASIC), in place of or in addition to the general-purpose processor. “Processing circuitry” refers to a general-purpose processor, a dedicated processor, or a combination thereof.

The programs such as the emotion estimation program may be stored in a computer-readable recording medium and provided to the computer 200. In this case, the computer 200 includes a drive for reading data from the recording medium, and acquires the programs from the recording medium. Examples of the recording medium include a magnetic disk, an optical disk (such as a CD-ROM, a CD-R, a DVD-ROM, and a DVD-R), a magnetooptical disk (such as an MO), and a semiconductor memory. The programs may be distributed via a communication network. Specifically, the programs may be stored in a server on a communication network to allow the computer 200 to download the programs from the server.

### First Embodiment

In a first embodiment, processing to be executed by the emotion estimation apparatus 100 shown in FIG. 1 will be described, with respect to an example in which medium data is speech data.

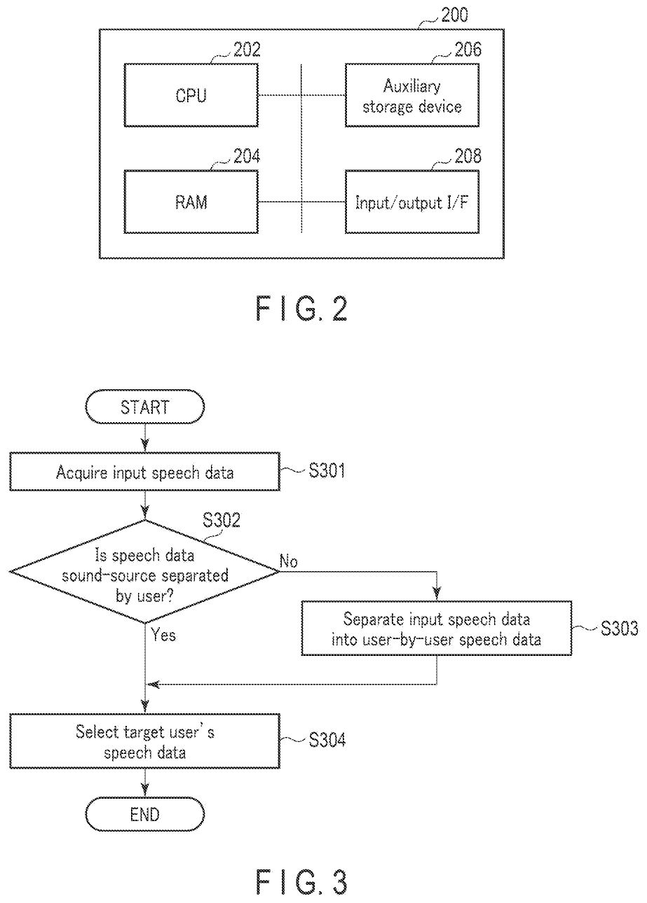

FIG. 3 schematically shows an operation of an acquisition unit 102. At step S301 in FIG. 3, the acquisition unit 102 acquires speech data from the medium data acquisition device. In an application in a call center that handles telephone speech, for example, a built-in microphone of a smartphone or a telephone handset, a microphone connected to a personal computer, or the like is used as the medium data acquisition device. In an application in a meeting, for example, a desktop microphone, a headset microphone, etc. connected to a personal computer is used as the medium data acquisition device.

If speech data is sound-source separated by user (step S302; Yes), the flow advances to step S304; if speech data is not sound-source separated by user (step S302; No), the flow advances to step S303. If telephone speech is to be recorded or speech is to be recorded with a headset microphone, since user-by-user speech can be recorded, the speech data will be sound-source separated. On the other hand, if speech at a meeting is to be recorded with a desktop microphone, a plurality of users' mixed speech will be recorded in the speech data. In this case, the acquisition unit 102 separates the speech by user by means of sound source separation (step S303). The sound source separation can be realized by a publicly known technique.

At step S304, the acquisition unit 102 selects a target user's speech from the user-by-user separated speech, and outputs speech data in which the target user's speech is recorded. For example, the acquisition unit 102 associates the separated speech with user information and presents it to the system user, to allow the system user to select, from the separated speech, the speech of the target for emotion estimation (i.e., the speech of the target user). In this case, the target user information is an input made by the system user. Also, if the target user's speech is obtained in advance, the acquisition unit 102 may calculate a similarity between the target user's speech obtained in advance and the separated speech, and automatically select separated speech with the highest similarity as the target user's speech. In this case, the target user information is the target user's speech obtained in advance.

In this manner, the acquisition unit 102 receives speech data acquired by the medium data acquisition device as input speech data, and extracts the target user's speech data from the input speech data.

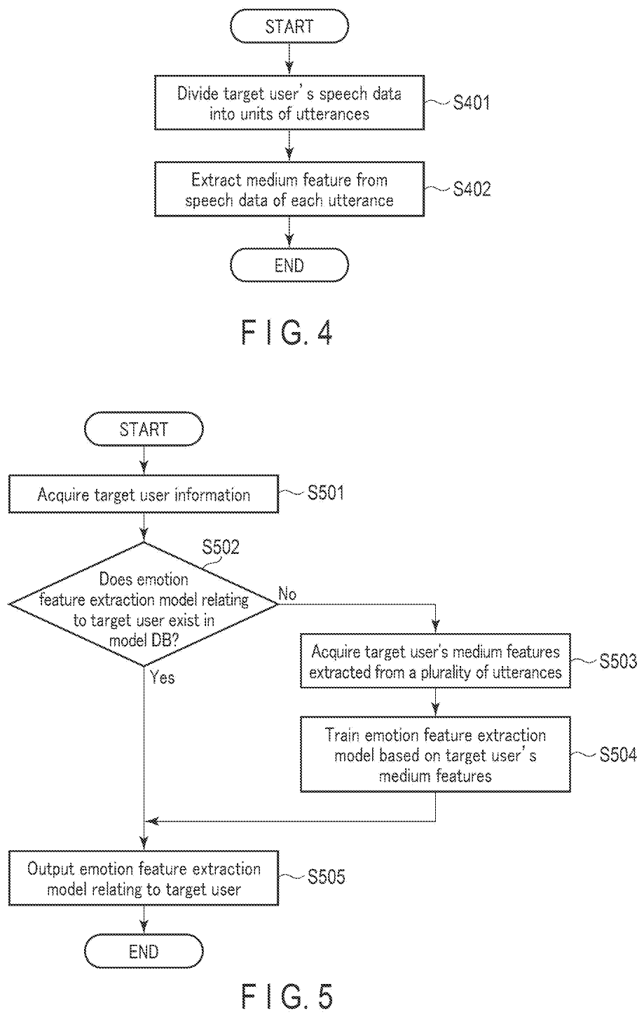

FIG. 4 schematically shows an operation of the medium feature extraction unit 104. At step S401 in FIG. 4, the medium feature extraction unit 104 divides the target user's speech data into units of utterances. Herein, an “utterance” refers to a time interval (hereinafter referred to as a “speech interval”) during which a speech interposed by silent intervals equal to or longer than a predetermined period of time (typically 0.2 seconds) exists. Specifically, the medium feature extraction unit 104 detects a speech interval by speech interval detection. The speech interval detection can be realized by a publicly known technique. Subsequently, the medium feature extraction unit 104 divides the target user's speech data into units of utterances based on the detected speech interval.

At step S402, the medium feature extraction unit 104 extracts, for each analytical frame, medium features from each utterance made by the target user. Specifically, the medium feature extraction unit 104 divides speech data corresponding to each utterance into analytical frames, and extracts medium features from speech data corresponding to each analytical frame. As an example, speech data corresponding to each utterance is divided into analytical frames with a frame length of 25 milliseconds and a frame shift of 10 milliseconds. Examples of the medium features that may be used include, but are not limited to, the power spectra, mel-filterbank features, mel-frequency cepstral coefficients (MFCC), and outputs from intermediate layers of speech processing NNs such as NN acoustic models and NN emotion models.

In this manner, the medium feature extraction unit 104 extracts medium features from the target user's speech data.

FIG. 5 schematically shows an operation of the model output unit 106. At step S501 of FIG. 5, the model output unit 106 acquires target user information for specifying the target user. At this step, the target user information acquired by the acquisition unit 102 may be referred to.

At step S502, the model output unit 106 confirms, based on the target user information, whether or not an emotion feature extraction model relating to the target user exists in the model DB 112. If an emotion feature extraction model relating to the target user exists in the model DB 112 (step S502; Yes), the model output unit 106 reads, from the model DB 112, the emotion feature extraction model relating to the target user, and provides the emotion feature extraction model relating to the target user to the emotion feature calculation unit 108 (step S505).

If an emotion feature extraction model relating to the target user does not exist in the model DB 112 (step S502; No), the flow advances to step S503. At step S503, the model output unit 106 acquires the target user's medium features extracted by the medium feature extraction unit 104 from a plurality of utterances.

At step S504, the model output unit 106 trains the emotion feature extraction model relating to the target user based on the acquired medium features extracted from the plurality of utterances, and registers the trained emotion feature extraction model in the model DB 112. Subsequently, at step S505, the model output unit 106 provides the emotion feature extraction model relating to the target user to the emotion feature calculation unit 108.

The determination as to whether or not an emotion feature extraction model relating to the target user exists in the model DB 112 may be left to the system user. That is, the model output unit 106 may determine, based on the system user's input, whether or not an emotion feature extraction model relating to the target user exists in the model DB 112. As an example, the model output unit 106 presents, to the system user, a list of emotion feature extraction models registered in the model DB 112 to allow the system user to confirm whether or not an emotion feature model relating to the target user exists in the model DB 112. For example, if an emotion feature model relating to the target user exists, the model output unit 106 selects an emotion feature model relating to the target user from the list, and if an emotion feature model relating to the target user does not exist, causes the display device to display an image requesting the system user to select creation of a new emotion feature model.

The model DB 112 may be configured to further store speech data used for training each emotion feature extraction model in association with the emotion feature extraction model. In this case, the model output unit 106 can automatically determine whether or not the emotion feature extraction model relating to the target user exists in the model DB 112 by obtaining a similarity between the target user's speech data and the speech data associated with each emotion feature extraction model. For example, the model output unit 106 obtains a similarity between the target user's speech data and speech data associated with each emotion feature extraction model, and specifies, as the emotion feature extraction model relating to the target user, an emotion feature extraction model associated with speech data having a similarity to the target user's speech data exceeding a predetermined threshold value.

A process of training an emotion feature extraction model shown in step S504 will be described.

The model output unit 106 selects, as training data, medium features of N utterances from all the utterances of the target user acquired by the acquisition unit 102. N may be the same as the number of acquired utterances of the target user. A series Sₙ of medium features of the target user is defined as follows.

$${S}_{n} = [ {s}_{1}^{n} , {s}_{2}^{n} , … {s}_{t}^{n} , … , {s}_{{T}_{n}}^{n} ] ( 1 ≦ n ≦ N , 1 ≦ t ≦ {T}_{n} ) \qquad ( 1 )$$

Sₙ is a matrix of K rows and Tₙ columns. n is an index allocated to the target user's utterance to be used as training data. t is an index allocated to an analytical frame, sₜⁿ is a k-dimensional medium feature vector in a t-th frame, and Tₙ is a series length of the medium feature series Sₙ.

Thereafter, the model output unit 106 generates an emotion feature extraction model relating to the target user based on the medium features of N utterances. As the emotion feature extraction model, a model expressing a statistic of the medium features in the training data is used. For example, the emotion feature extraction model may be defined by the following Formula (2) or (3).

$$m = [ mean ( [ {S}_{1} , {S}_{2} , … , {S}_{N} ] ) ] \qquad ( 2 )$$

$$m = [ var ( [ {S}_{1} , {S}_{2} , … , {S}_{N} ] ) ] \qquad ( 3 )$$

Here, [S₁, S₂, . . . , S_{N}] is a matrix of K rows and Σᵢ₌₁^{N}Tᵢ columns, shown below.

$$[ {S}_{1} , {S}_{2} , … , {S}_{N} ] = \qquad ( 4 )$$

$$[ {s}_{1}^{1} , {s}_{2}^{1} , … , {s}_{{T}_{1}}^{1} , {s}_{1}^{2} , {s}_{2}^{2} , … , {s}_{{T}_{2}}^{2} , … , {s}_{1}^{N} , {s}_{2}^{N} , … , {s}_{{T}_{N}}^{N} ]$$

The “mean( )” represents a computation of taking a mean of elements for each row of the matrix, namely, a computation of obtaining a mean of frame directions for each element of the feature vector. The “var( )” represents a computation of taking a variance of elements for each row of the matrix, namely, a computation of obtaining a variance of frame directions for each element of the feature vector. m is a symbol representing an emotion feature extraction model, and is, in the case of Formula (2) or (3), a k-dimensional vector.

A vector obtained by concatenating the vector of Formula (2) and the vector of Formula (3) may be used as an “emotion feature extraction model m”.

The emotion feature extraction model m is not limited to the above-described one. For example, a Gaussian mixture model (GMM) in which distributions of medium features are modeled using all the medium feature series Sₙ (1≤n≤N) may be used. In this case, a GMM super vector, which is a vector obtained by concatenating mean components of the GMM, is used as the emotion feature extraction model m. Training of the GMM can be realized by a publicly known technique.

Thereby, the model output unit 106 outputs the emotion feature extraction model relating to the target user.

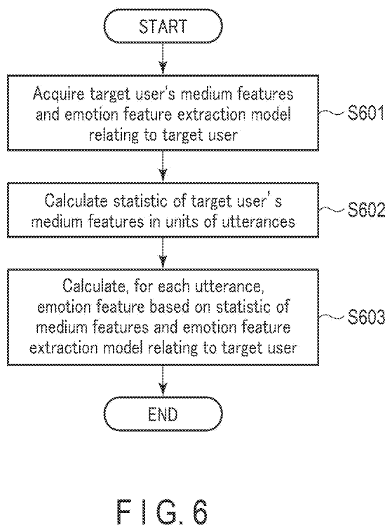

FIG. 6 schematically shows an operation of the emotion feature calculation unit 108. At step S601 of FIG. 6, the emotion feature calculation unit 108 receives the target user's medium features from the medium feature extraction unit 104, and receives an emotion feature extraction model m relating to the target user from the model output unit 106. It is assumed that the number of utterances made by the target user is N′. Here, N≤N′ is satisfied. A medium feature series U_{n′} of the target user used for calculation of an emotion feature of each utterance is represented as follows.

$${U}_{{n}^{′}} = [ {u}_{1}^{{n}^{′}} , {u}_{2}^{{n}^{′}} , … {u}_{t}^{{n}^{′}} , … , {u}_{{T}_{{n}^{′}}}^{{n}^{′}} ] ( 1 ≦ {n}^{′} ≦ {N}^{′} , 1 ≦ t ≦ {T}_{{n}^{′}} ) \qquad ( 5 )$$

Here, U_{n′} is a matrix of K rows and T_{n′} columns. n′ is an index allocated to an utterance made by the target user. t is an index allocated to an analytical frame, Uₜ^{n′} is a k-dimensional medium feature vector in a t-th frame, and T_{n′} is a series length of the medium feature series U_{n′}. It is to be noted that data of U_{n′} (1≤n′≤N′) and data of Sₙ (1≤n≤N), which have been mentioned above with respect to the model output unit 106, partially overlap one another.

At step S602, the emotion feature calculation unit 108 acquires, for each utterance, a statistic in the target user's medium feature series U_{n′}. It is assumed that a symbol expressing the statistic of U_{n′} (1≤n′≤N′) is M_{n′}.

If the emotion feature extraction model m is denoted by Formula (2), M_{n′} is denoted by Formula (6).

$${M}_{{n}^{′}} = [ mean ( {U}_{{n}^{′}} ) ] \qquad ( 6 )$$

Here, “mean( )” represents a computation of taking a mean of elements for each row of the matrix.

If the model m is denoted by Formula (3), M_{n′} is denoted by Formula (7).

$${M}_{{n}^{′}} = [ var ( {U}_{{n}^{′}} ) ] \qquad ( 7 )$$

Here, “var( )” represents a computation of taking a variance of elements for each row of the matrix.

If Formula (6) or (7) is used, M_{n′} will be a K-dimensional vector.

If a GMM is used for training the model m, the statistic of U_{n′} is modeled using the GMM as a prior distribution, and a GMM super vector, which is a vector obtained by concatenating mean components obtained thereby, is obtained as M_{n′}.

At step S603, the emotion feature calculation unit 108 acquires, for each utterance, an emotion feature based on the statistic of the medium features acquired per unit of utterance and the emotion feature extraction model m relating to the target user. It is assumed that an emotion feature in U_{n′} (1≤n′≤N′) is E_{n′}.

The emotion feature calculation unit 108 calculates, as shown in Formula (8) below, a difference between the emotion feature extraction model m relating to the target user and the statistic M_{n′} of the medium features, and uses the calculated difference as the emotion feature E_{n′}.

$${E}_{{n}^{′}} = m - {M}_{{n}^{′}} \qquad ( 8 )$$

Also, if a GMM is used for training of the emotion feature extraction model m and calculation of the statistic M_{n′}, the emotion feature calculation unit 108 may calculate, taking GMM information into consideration, the emotion feature E_{n′} representing a difference between the emotion feature extraction model m relating to the target user and the statistic M_{n′} of the medium features.

In this manner, the emotion feature calculation unit 108 calculates the target user's medium features in units of utterances, and calculates, for each utterance, an emotion feature based on a difference between the emotion feature extraction model m relating to the target user and the utterance-by-utterance medium features.

The emotion estimation unit 110 estimates, for each utterance, the target user's emotion based on the target user's emotion feature. Specifically, the emotion estimation unit 110 calculates, based on the target user's emotion feature E_{n′} (1≤n′≤N′), a vector O_{n′} (1≤n′≤N′) representing probabilities of emotions in each utterance made by the target user. Assuming that P types of emotions are to be estimated, O_{n′} is a P-dimensional vector. Examples of the model that may be used for calculating O_{n′} from the emotion feature E_{n′} include, but are not limited to, a decision tree and an NN. For estimation of O_{n′}, a medium feature series U_{n′} may be used, in addition to the emotion feature E_{n′}.

The emotion estimation apparatus 100 can be operated either in an offline operation or a real-time operation. The offline operation is a mode in which the emotion estimation apparatus 100 is operated after speech recording ends, for example, after an end of a meeting or an end of a call at a call center. A real-time operation is a mode in which the emotion estimation apparatus 100 is operated while a speech recording is being made, for example, during a meeting or during a call at a call center.

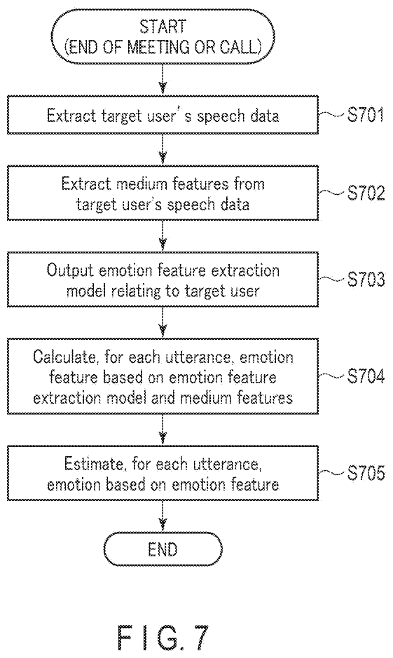

FIG. 7 schematically shows an emotion estimation process in an offline operation executed by the emotion estimation apparatus 100. The emotion estimation process shown in FIG. 7 is started after the end of speech recording.

At step S701, the acquisition unit 102 acquires speech data obtained by speech recording, and extracts the target user's speech data from the acquired speech data.

At step S702, the medium feature extraction unit 104 extracts medium features from the target user's speech data. The medium feature extraction unit 104 divides the target user's speech data into units of utterances, and calculates a series of the medium features from the speech data corresponding to each utterance.

At step S703, the model output unit 106 outputs an emotion feature extraction model relating to the target user. For example, the model output unit 106 determines whether or not an emotion feature extraction model relating to the target user exists in the model DB 112. If an emotion feature extraction model relating to the target user exists in the model DB 112, the model output unit 106 retrieves the emotion feature extraction model relating to the target user from the model DB 112, and provides it to the emotion feature calculation unit 108. If an emotion feature extraction model relating to the target user does not exist in the model DB 112, the model output unit 106 receives plural medium feature series in a plurality of utterances from the medium feature extraction unit 104, calculates, in accordance with Formula (2) or Formula (3), an emotion feature extraction model relating to the target user from the plural medium feature series in the plurality of utterances, and provides it to the emotion feature calculation unit 108.

At step S704, the emotion feature calculation unit 108 calculates, for each utterance, an emotion feature based on the emotion feature extraction model and the medium features. For example, the emotion feature calculation unit 108 calculates, for each utterance, a statistic of medium features in accordance with Formula (6) or Formula (7), and calculates, for each utterance, a difference between the emotion feature extraction model and the statistic of the medium features as an emotion feature in accordance with Formula (8).

At step S705, the emotion estimation unit 110 estimates, for each utterance, the target user's emotion based on the emotion feature.

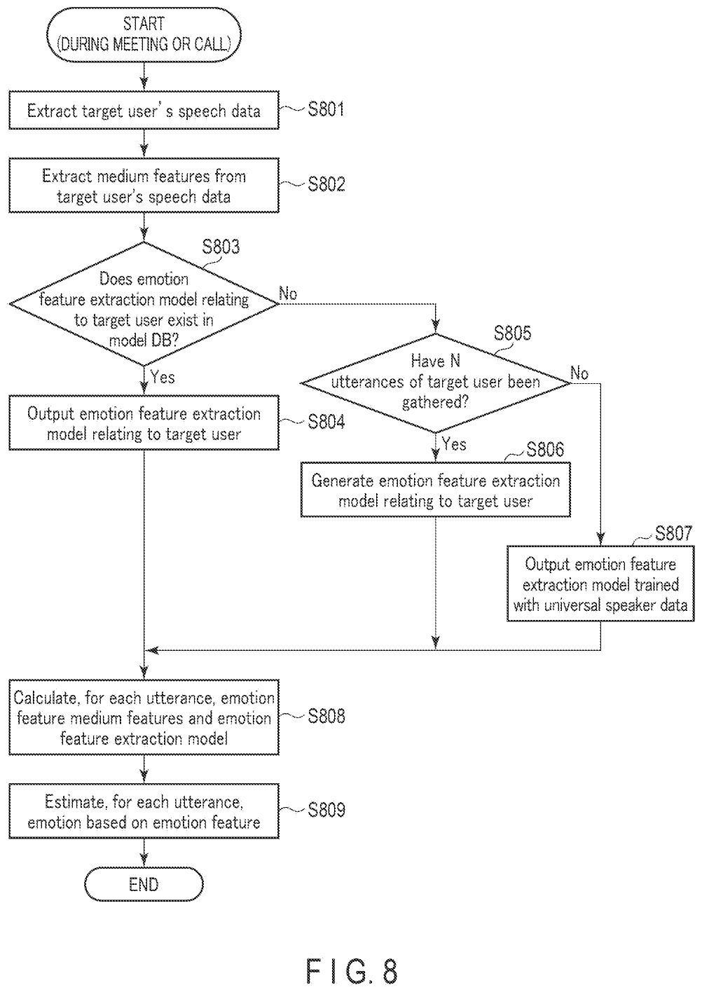

FIG. 8 schematically shows an emotion estimation process in a real-time operation executed by the emotion estimation apparatus 100. The emotion estimation process shown in FIG. 8 is started upon start of speech recording. For example, the medium data acquisition device provides speech data obtained by speech recording to the emotion estimation apparatus 100 in real time.

At step S801, the acquisition unit 102 extracts the target user's speech data from the speech data received from the medium data acquisition device. At step S802, the medium feature extraction unit 104 extracts medium features from the target user's speech data. For example, the medium feature extraction unit 104 extracts, upon detecting an end of a single utterance made by the target user, medium features from speech data corresponding to the utterance.

At step S803, the model output unit 106 confirms whether or not an emotion feature extraction model relating to the target user exists in the model DB 112. If an emotion feature extraction model relating to the target user exists in the model DB 112 (step S803; Yes), at step S804, the model output unit 106 reads, from the model DB 112, the emotion feature extraction model relating to the target user, and provides the emotion feature extraction model relating to the target user to the emotion feature calculation unit 108.

On the other hand, if an emotion feature extraction model relating to the target user does not exist in the model DB 112 (step S803; No), at step S805, the model output unit 106 determines whether or not N utterances of the target user have been gathered. If N utterances of the target user have been gathered (step S805; Yes), at step S806, the model output unit 106 trains an emotion feature extraction model relating to the target user based on speech data of the N utterances of the target user. Specifically, the model output unit 106 calculates, in accordance with Formula (2) or (3) above, an emotion feature extraction model relating to the target user from the medium features extracted by the medium feature extraction unit 104 from the speech data of the N utterances of the target user. The model output unit 106 provides the trained emotion feature extraction model to the emotion feature calculation unit 108, and registers it in the model DB 112.

If N utterances of the target user have not been gathered (step S805; No), at step S807, the model output unit 106 reads an emotion feature extraction model relating to a universal user from the model DB 112, and provides it to the emotion feature calculation unit 108. The emotion feature extraction model relating to the universal user denotes an emotion feature extraction model that has been trained using universal speaker data.

The flow advances from step S804, step S806, or step S807 to step S808. At step S808, the emotion feature calculation unit 108 calculates, in accordance with Formula (6) or (7), a statistic of the medium features from the medium features in a single utterance obtained at step S802, based on the difference between the statistic of the medium features and the emotion feature extraction model received from the model output unit 106, in accordance with Formula (8) shown above.

At step S809, the emotion estimation unit 110 estimates a target user's emotion based on the emotion feature calculated by the emotion feature calculation unit 108.

The above-described processing is repeated until the meeting or call comes to an end. If an emotion feature extraction model relating to the target user does not exist in the model DB 112, the emotion estimation apparatus 100 performs emotion estimation using an emotion feature extraction model relating to the universal user until N utterances of the target user are gathered. If N utterances of the target user are gathered, the emotion estimation apparatus 100 generates an emotion feature extraction model relating to the target user, and performs emotion estimation for the subsequent utterances using the emotion feature extraction model relating to the target user.

As described above, the emotion estimation apparatus 100 performs emotion estimation based on a difference between an emotion feature extraction model that has been trained based on a plurality of utterances made by the target user and an emotion feature for each utterance. It is thereby possible to perform emotion estimation in view of the amount of change from the characteristics of the way of speaking of the target user at normal times, without excessively depending on the characteristics of the way of speaking of the target user at normal times. As a result, it is possible to perform emotion estimation with high precision.

The present inventors have performed evaluation experiments of emotion estimation according to the embodiment. In the experiments, the Ryerson Audio-Visual Database of Emotional Speech and Song (RAVDESS) dataset, which contains English-language speech vocalized by actors, was used. In the RAVDESS dataset, eight types of speech emotions vocalized by 24 actors are recorded. In the experiments, 90% of the RAVDESS dataset was selected as training data, and 10% was selected as evaluation data.

In the experiments, a baseline approach and a proposal approach (the above-described approach according to the embodiment) were compared.

In the baseline approach, an emotion estimation NN, which performs emotion estimation using, as an input, a mel filterbank feature extracted from speech data, is trained with training data.

In the proposal approach, a mel filter bank feature extracted from training data is input to the emotion estimation NN trained by the baseline approach, and thereby information output from an intermediate layer selected from a plurality of intermediate layers of the emotion estimation NN is obtained as medium features, and an emotion feature extraction model is generated therefrom. Moreover, an emotion estimation NN having the same structure as the structure from the selected intermediate layer to the output layer in the emotion estimation NN trained by the baseline approach is prepared separately, and the emotion estimation NN is trained to perform emotion estimation using an emotion feature as an input.

The emotion recognition accuracy rate was 68.1% in the baseline approach, and was 70.0% in the proposal approach. From these experimental results, it can be seen that the proposal approach offers more favorable properties than the baseline approach. Accordingly, it can be seen that the proposal approach contributes to improvement in the emotion estimation properties.

### Second Embodiment

In the second embodiment, a case will be described where medium data is text data. In the second embodiment, the emotion estimation apparatus 100 shown in FIG. 1 will be referred to. Regarding each constituent element, differences from the first embodiment will be described, and a description of similarities to the first embodiment will be omitted.

The acquisition unit 102 acquires text data of a target user. The text data of the target user may be, for example, data of sentences included in an e-mail transmitted by the target user, or may be data of text obtained by speech recognition of an utterance made by the target user. The acquisition unit 102 divides the text into units of sentences.

The medium feature extraction unit 104 divides each sentence obtained by the acquisition unit 102 into a sequence of words by morphological analysis. Subsequently, the medium feature extraction unit 104 obtains a medium feature series of each sentence by extracting a medium feature from each word. Examples of the medium features that may be used include, but are not limited to, outputs from an intermediate layer of a language processing NN, such as Bidirectional Encoder Representations from Transformers (BERT).

The subsequent processes, namely, the processing at the model output unit 106, the emotion feature calculation unit 108, and the emotion estimation unit 110, are similar to those in the first embodiment.

### Third Embodiment

In the third embodiment, a case will be described where medium data is moving image data. In the third embodiment, the emotion estimation apparatus 100 shown in FIG. 1 will be referred to. Regarding each constituent element, differences from the first embodiment will be described, and a description of similarities to the first embodiment will be omitted.

The acquisition unit 102 acquires moving image data of a target user. For example, the acquisition unit 102 receives moving image data from a medium data acquisition device such as a camera. The acquisition unit 102 performs automatic human detection on moving image data, and causes the moving image data to be displayed on a display device along with results of the automatic human detection. The acquisition unit 102 selects a person specified by an input from the system user as a target user, and acquires moving image data of the target user while tracking the target user by automatic human tracking. The automatic human detection and the automatic human tracking can be realized by a publicly known technique.

The medium feature extraction unit 104 obtains a plurality of moving image segments by cutting the user's moving image every predetermined period (e.g., two seconds). The medium feature extraction unit 104 obtains a medium feature series for each moving image segment. Examples of the medium features that may be used include, but are not limited to, outputs from an intermediate layer of an image processing NN, such as a human recognition NN that takes an image as an input and identifies a person.

The subsequent processes, specifically, the processing at the model output unit 106, the emotion feature calculation unit 108, and the emotion estimation unit 110, are similar to those described in the first embodiment.

According to the above-described embodiments, emotion estimation is performed based on a difference between an emotion feature extraction model denoting a reference for the target user's medium features and an emotion feature of the processing unit. It is thereby possible to perform emotion estimation in view of the amount of change from the characteristics of the behavior (e.g., the way of speaking, the motion, or the language) of a target user at normal times, without excessively depending on the characteristics of the behavior of the target user at normal times. As a result, it is possible to perform emotion estimation with high precision.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An emotion estimation apparatus comprising processing circuitry configured to:
acquire medium data of a target user in which a medium of the target user is recorded;
extract medium features from the medium data of the target user;
calculate an emotion feature based on the extracted medium features and an emotion feature extraction model denoting a reference for the medium features of the target user; and
estimate an emotion of the target user based on the calculated emotion feature.

2. The emotion estimation apparatus according to claim 1, wherein
the processing circuitry is further configured to acquire the emotion feature extraction model from a model database to calculate the emotion feature.

3. The emotion estimation apparatus according to claim 2, wherein
the processing circuitry is configured to:
determine whether or not the emotion feature extraction model exists in the model database;
acquire the emotion feature extraction model from the model database if the emotion feature extraction model exists in the model database; and
train the emotion feature extraction model based on the medium data of the target user if the emotion feature extraction model does not exist in the model database, and register the trained emotion feature extraction model in the model database.

4. The emotion estimation apparatus according to claim 3, wherein
the processing circuitry generates the emotion feature extraction model by calculating a statistic of medium features extracted from at least a part of the medium data of the target user.

5. The emotion estimation apparatus according to claim 1, wherein
the processing circuitry is configured to:
calculate, for each processing unit in which emotion estimation is to be performed, a statistic of the extracted medium features, and
calculate, for each processing unit, the emotion feature based on a difference between the calculated statistic of the extracted medium features and the emotion feature extraction model.

6. The emotion estimation apparatus according to claim 1, wherein
the processing circuitry receives medium data acquired by the medium data acquisition device and target user information for specifying the target user, and extracts the medium data of the target user from the received medium data based on the received target user information.

7. The emotion estimation apparatus according to claim 1, wherein
the medium includes any of a speech, a moving image, or text.

8. An emotion estimation method executed by an emotion estimation apparatus, the method comprising:
acquiring medium data of a target user in which a medium of the target user is recorded;
extracting medium features from the medium data of the target user;
calculating an emotion feature based on the extracted medium features and an emotion feature extraction model denoting a reference for the medium features of the target user; and
estimating an emotion of the target user based on the calculated emotion feature.

9. A non-transitory computer readable medium including computer executable instructions, wherein the instructions, when executed by a processor, cause the processor to perform a method comprising:
acquiring medium data of a target user in which a medium of the target user is recorded;
extracting medium features from the medium data of the target user;
calculating an emotion feature based on the extracted medium features and an emotion feature extraction model denoting a reference for the medium features of the target user; and
estimating an emotion of the target user based on the calculated emotion feature.
